(19) United States
(12) Patent Application Publication
(10) Pub. No.: US 2009/0003290 A1
(43) Pub. Date: Jan. 1, 2009

(54) Method and Apparatus for Selecting Transport Format Combination in a Wireless Communication System

(75) Inventor: Seung-Hyun Lee, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., SUWON-SI, GYEOGGI-DO (KR)

(21) Appl. No.: 12/161,086

(22) PCT Filed: Jul. 26, 2007
(86) PCT No.: PCT/KR07/00263

§ 371 Date: Jul. 16, 2008

(30) Foreign Application Priority Data
Jan. 18, 2006 (KR) 2006-5391

(51) Int. Cl. H04J 3/00

(52) U.S. Cl. 370/336

(57) ABSTRACT

A method and apparatus for selecting a Transport Format Combination (TFC) in a wireless communication system are provided, in which it is determined whether a previous TFC used for data transmission on a previous valid Transmission Time Interval (TTI) can be reused as a current TFC for data transmission on a current valid TTI via at least one transport channel according to at least one parameter related to the transport channel, the previous TFC is set as the current TFC without performing a TFC search and determination process, when the previous TFC can be reused on the current valid TTI, and TFCs, each having Transport Formats (TFs) preset for data transmission on transport channels are searched, and a suitable TFC is selected for the current valid TTI from among the TFCs when the previous TFC cannot be reused on the current valid TTI.

### PRIORITY

This application claims priority to Korean Patent Application Number 2006-5391, which was filed on Jan. 18, 2006, and to Patent Cooperation Treaty (PCT) application number PCT/KR2007/000263, which was filed on Jan. 16, 2007, the disclosures of each of which are hereby incorporated by reference.

### BACKGROUND OF THE INVENTION

1. Field of the Invention

The present invention generally relates to a wireless communication system. More particularly, but not exclusively, the present invention relates to a method and apparatus for selecting a Transport Format Combination (TFC).

2. Description of the Related Art

A 3^{rd} Generation (3G) mobile communication system using Wideband Code Division Multiple Access (WCDMA), called Universal Mobile Telecommunication Service (UMTS), which is based on European mobile communication systems, Global System for Mobile communications (GSM) and General Packet Radio Services (GPRS), provides mobile subscribers or computer users with a uniform service of transmitting packet-based text, digitized voice, and video and multimedia data at or above 2 Mbps (Megabits per second), irrespective of their locations around the world. With the introduction of the concept of virtual access, the UMTS system allows access to any end point within a network all the time. The virtual access refers to packet-switched access using a packet protocol such as Internet Protocol (IP).

To send data or control information, the UMTS system uses different types of logical channels, transport channels onto which the logical channels are mapped, and physical channels onto which the transport channels are mapped. Each logical channel is associated with a certain type and Quality of Service (QoS) of information that the logical channel carries. The logical channels include the Downlink (DL) Broadcast Control Channel (BCCH), DL Paging Channel (PCCH), Uplink (UL)/DL Dedicated Control Channel (DCCH), UL/DL Common Control Channel (CCCH), UL/DL Shared Channel Control Channel (SHCCH), UL/DL Dedicated Traffic Channel (DTCH), and DL Common Traffic Channel (CTCH). The DL BCCH, DL PCCH, UL/DL DCCH, UL/DL CCCH, and UL/DL SHCCH are control channels, and the UL/DL DTCH and DL CTCH are traffic channels. The transport channels are defined by how they transfer data over the radio interface and the characteristics of the data. Common transport channels are the UL Random Access Channel (RACH), UL Common Packet Channel (CPCH), DL Forward Access Channel (FACH), DL Downlink Shared Channel (DSCH), UL Uplink Shared Channel (USCH), DL Broadcast Channel (BCH), and DL Paging Channel (PCH). A dedicated transport channel is the UL/DL Dedicated Channel (DCH). Each transport channel is mapped to one or more physical channels according to its physical characteristics.

A Transport Format (TF) describes attributes for delivery of Transport Blocks (TBs) on a transport channel. The attributes include, for example, TB size, Transmission Time Interval (TTI), coding scheme, code rate, size of Cyclic Redundancy Check (CTC), etc. A plurality of transport channels are multiplexed into a Coded Composite Transport Channel (CCTrCH), and the CCTrCH is mapped to one or more physical channels. A Transport Format Combination (TFC) refers to a combination of TFs of dedicated transport channels mapped onto a single CCTrCH. A set of all available TFCs for the CCTrCH is referred to as a Transport Format Combination Set (TFCS).

The TFCs are identified by Transport Format Combination Indicators (TFCIs). For example, a Node B determines a TFCI for DL transport channels, and a User Equipment (UE) decodes and demultiplexes data from the transport channels by interpreting the TFCI. The Transport channels are identified by Transport Channel Indicators.

TFC Selection for UL or DL transmission data is critical in terms of transmission efficiency. For TFC selection, logical channels are mapped to transport channels with appropriate TFs, which takes place at every boundary of the shortest TTI. Existing TFC selection processes detect an optimal TFC by mapping each logical channel with an available priority level to every transport channel. Therefore, even an optimized TFC selection process may have a long processing time, leading to an increase of processing loads, and thus impeding high-speed wireless communications.

### SUMMARY OF THE INVENTION

The present invention substantially addresses at least the problems and/or disadvantages enumerated above and provides at least the advantages described below. Accordingly, an aspect of the present invention is to provide a method and apparatus for reducing the processing time taken for TFC selection in a wireless communication system.

Another aspect of the present invention provides a method and apparatus for reducing the number of occurrences of a TFC search and determination process for selecting an optimal TFC by searching logical channels and transport channels according to a higher layer-requested priority level in a wireless communication system.

A further aspect of the present invention provides a method and apparatus for reducing the number of occurrences of a TFC search and determination process for selecting a TFC for dedicated channels utilizing high rates.

In accordance with an aspect of the present invention, there is provided a method of selecting a TFC for transport channels in a wireless communication system, in which a transmitter determines whether a previous TFC used for data transmission on a previous valid TTI can be reused as a current TFC for data transmission on a current valid TTI via at least one transport channel according to at least one parameter related to the transport channel. The previous TFC is set as the current TFC without performing a TFC search and determination process, when the previous TFC can be reused on the current valid TTI, and TFCs, each having TFs preset for data transmission on transport channels are searched and a suitable TFC is selected for the current valid TTI from among the TFCs, when the previous TFC cannot be reused on the current valid TTI.

In accordance with another aspect of the present invention, there is provided an apparatus for selecting a TFC for transport channels in a wireless communication system, in which a Radio Link Control (RLC) buffer buffers data to be sent on logical channels. A multiplexer (MUX) multiplexes data to be sent on logical channels to be mapped onto the same transport channel among the logical channels and provides the multiplexed data to a physical layer, a selector selects a TFC for data transmission on at least one transport channel available for a current valid TTI. A controller controls the RLC buffer to end the buffered data to the physical layer via the MUX or directly, according to the selected TFC. The selector is configured to determine whether a previous TFC used for data transmission on a previous valid TTI can be reused on the current valid TTI via at least one transport channel according to at least one parameter related to the transport channel, set the previous TFC as a current TFC without performing a TFC search and determination process when the previous TFC can be reused on the current valid TTI, search TFCs each having TFs preset for data transmission on transport channels, and select a suitable TFC for the current valid TTI from among the TFCs when the previous TFC cannot be reused on the current valid TTI.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates a configuration of a UMTS Terrestrial Radio Access Network (UTRAN) in a UMTS system according to the present invention;

FIG. 2 illustrates the hierarchical protocol architecture of a Uu interface between a User Equipment (UE) and a Radio Network Controller (RNC) according to the present invention;

FIG. 3 illustrates a transmission according to the present invention;

FIG. 4 is a block diagram of a transmitter for selecting a Transport Format Combination (TFC) according to the present invention; and

FIG. 5 is a flowchart illustrating a TFC selection operation according to the present invention.

### DETAILED DESCRIPTION OF THE PREFERRED EMBODIMENTS

The following description is provided to assist in a better understanding of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Preferred embodiments of the present invention are intended to enable fast Transport Format Combination (TFC) selection in a high-speed wireless communication system. While the present invention will be described below in the context of an asynchronous Wideband Code Division Multiple Access (WCDMA) system complying with the 3^{rd} Generation Partnership Project (3GPP) standards, Universal Mobile Telecommunication Service (UMTS), it is to be clearly understood to those skilled in the art that the TFC selection of the present invention is applicable to any other mobile communication system with a similar technological background and channel configuration with a slight modification made within the scope of the present invention.

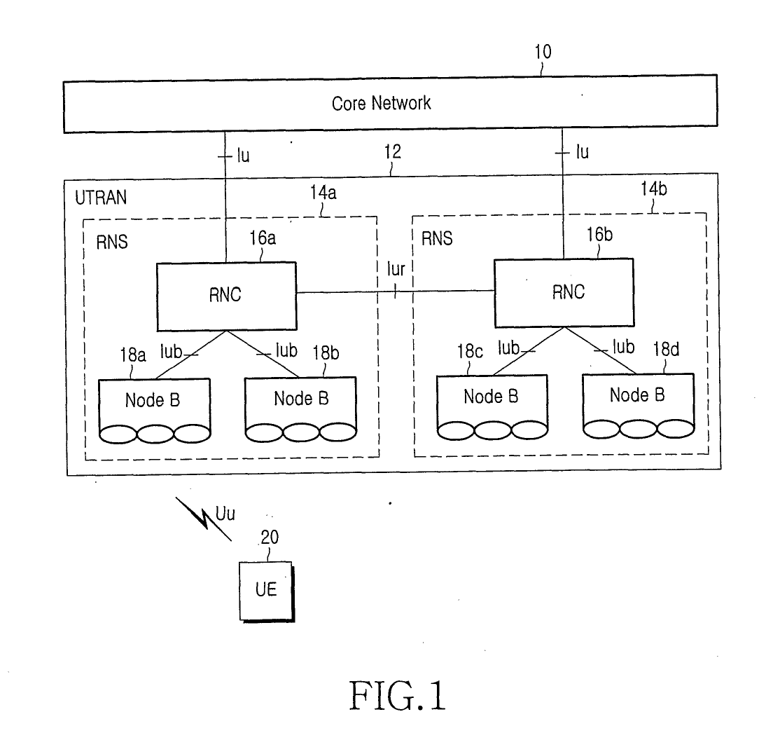

FIG. 1 shows a UMTS Terrestrial Radio Access Network (UTRAN) in a UMTS system according to the present invention.

Referring to FIG. 1, a UTRAN 12 includes Radio Network Controllers (RNCs) 16a and 16b and Node Bs 18a to 18d. The UTRAN 12 connects a User Equipment (UE) 20 to a Core Network (CN) 10. A plurality of cells may be managed by the Node Bs 18a to 18d. Each RNC 16a or 16b controls its Node Bs and each Node B controls its cells. Elements of FIG. 1 are interconnected through various interfaces including Uu, Iub, Iur, and Iu.

An RNC and Node Bs and its cells under the control of the RNC collectively form a Radio Network Subsystem (RNS) 14a or 14b. The RNCs 16a and 16b are connected to the Node Bs 18a to 18d via Iub interfaces, and the RNCs 14a and 14b are connected to each other via an Iur interface.

The RNCs 16a and 16b each allocate or manage radio resources to the Node Bs 18a to 18d under their control, and the Node Bs 18a to 18d function to actually provide the radio resources. The radio resources are configured on a cell basis, and the radio resources provided by the Node Bs 18a to 18d refer to radio resources of the cells that they manage. The UE 20 establishes a radio channel using radio resources provided by a particular cell under a particular Node B, for communications. From the point of view of the UE 20, a distinction between the Node Bs 18a to 18d and their controlled cells is meaningless, and the UE 20 deals only with a physical layer configured on a cell basis. Therefore, the terms “Node B” and “cell” are interchangeably used herein.

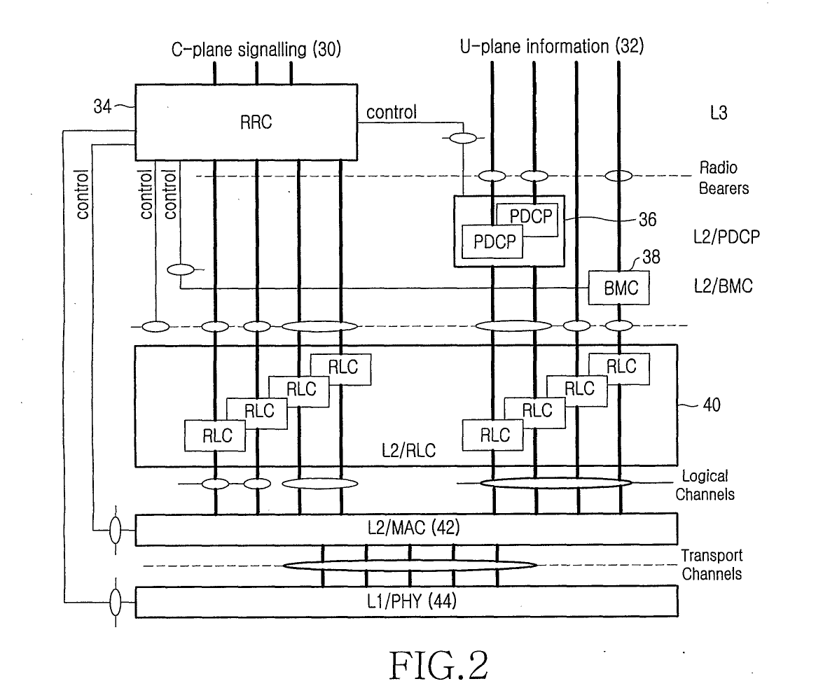

A Uu interface is defined between a UE and an RNC. A hierarchical protocol architecture of a Uu interface is shown in FIG. 2. Like the Iur or Iub interface, the Uu interface is considered a protocol stack configured for communications between nodes. This interface is divided into a control plane (C-plane) for exchanging control signals between the UE and the RNC, and a user plane (U-plane) for transmitting actual data.

Referring to FIG. 2, a C-plane signal 30 is processed in a Radio Resource Control (RRC) layer 34, a Radio Link Control (RLC) layer 40, a Medium Access Control (MAC) layer 42, and a physical (PHY) layer 44. U-plane information 32 is processed in a Packet Data Control Protocol (PDCP) layer 36, a Broadcast/Multicast Control (BMC) layer 38, the RLC layer 40, the MAC layer 42, and the PHY layer 44. The PHY layer 44 resides in each cell, and the MAC layer 42 through the RRC layer 34 are configured usually in each RNC.

The PHY layer 44 provides an information delivery service by radio transfer technology, corresponding to Layer 1 (L1) in an Open System Interconnection (OSI) model. The PHY layer 44 is connected to the MAC layer 42 via transport channels. The mapping relationship between the transport channels and physical channels is determined according to how data is processed in the PHY layer 44. The PHY layer 44 scrambles data with a cell-specific scrambling code and encodes the data with a physical channel-specific channelizaton code, for transmission in the air.

The MAC layer 42 is connected to the RLC layer 40 via logical channels. The MAC layer 42 delivers data received from the RLC layer 40 on the logical channels to the PHY layer 44 on appropriate transport channels, and delivers data received from the PHY layer 44 on the transport channels to the RLC layer 40 on appropriate logical channels. The MAC layer 42 inserts additional information or interprets inserted data in data received on the logical channels and controls random access.

The RLC layer 40 includes a plurality of RLC entities responsible for establishing and releasing the logical channels. Each RLC entity operates in one of an Acknowledged Mode (AM), an Unacknowledged Mode (UM) and a Transparent Mode (TM). For example, in the UM, an RLC entity segments or concatenates Service Data Units (SDUs) received from a higher layer to an appropriate size, and corrects errors by Automatic Repeat request (ARQ).

The PDCP layer 36 resides above the RLC layer 40 in the U-plane. The PDCP layer 36 is responsible for compression and decompression of the header of data carried in the form of an Internet Protocol (IP) packet and data delivery with integrity, in the case where a serving RNC is changed due to the UE's mobility. The BMC layer 38, which is above the RLC layer 40, supports the broadcasting service of sending the same data to a plurality of unspecified UEs in a particular cell.

Each time the RRC layer 40 receives a data request signal from the RLC layer 40, the RRC layer 40 sends a control signal for selecting a TFC for transport channels to the MAC layer 42. The MAC layer 42 selects a TFC in response to the control signal, taking into account a plurality of parameters, including the priority levels of the logical channels, an available maximum transmit power, a CODEC bit rate, and the like.

For example, the RRC layer 34 prioritizes eight logical channels between the RLC layer 40 and the MAC layer 42, and ranks them from the highest priority level 1 to the lowest priority level 8, for uplink data scheduling. The TFC selection is based on the priority levels of logical channels allocated by the RLC layer 40, and each time the RLC layer 40 sends a data request signal to the RRC layer 34, the MAC layer 42 selects an optimal TFC for data transmission under the control of the RRC layer 34. The selected TFC is a combination of TFs of the logical channels to be sent for a current TTI.

To render the priority-based transmission viable, part of the TBs of the logical channels may give way to data transmission of higher-priority logical channels under the control of the RRC layer 34. The priority level of the transmission-blocked TBs is reset to priority level 0, which is higher than the highest priority level 1, thus taking priority of transmission over TBs of any other priority level in a next TTI.

For the TFC selection, the MAC layer 42 has a TF table listing all available TFs for transport channels and determines a TF for each transport channel by searching the TF table under the RRC layer 34 when the RLC layer 210 requests data transmission. This operation is called a TFC search and determination process.

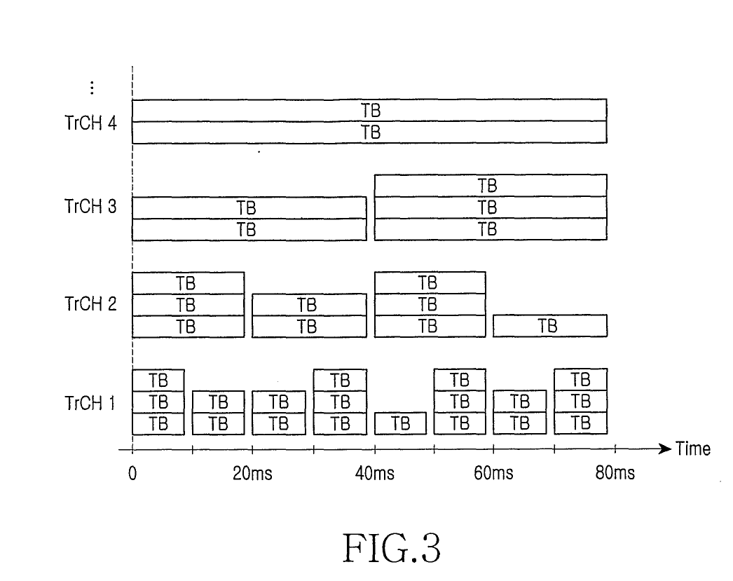

FIG. 3 shows a transmission according to the present invention. As shown in FIG. 3, a plurality of transport channels, TrCH 1 to TrCH 4, may be sent concurrently. A Transport Format Set (TFS) refers to a set of one or more TFs associated with a transport channel, and is determined by higher-layer signaling (specifically, RRC signaling). The four transport channels TrCH 1 to TrCH 4 have TTIs of 10, 20, 40 and 80 ms, respectively. One TB is transmittable for a TTI of a transport channel, and has a particular number of bits defined by the TF of the transport channel. The TF may change every TTI being selected from the TFS of the transport channel.

Referring to FIG. 3, a TFC applies to a TFC selection period corresponding to the shortest TTI (herein, 10 ms) of the currently established transport channels (i.e. active transport channels). The TFC is a combination of TFs for the active transport channels, variable every TFC selection period. In each TFC selection period, a TFC is selected from a particular TFCS defined as the set of all available TFCs for the active transport channels.

The TFC selection is divided into two parts. One is to select TFCs from the TFCS, which are available to send data reliable within the available maximum transmit power of a transmitter. These TFCs are referred to as valid TFCs. The other part is to select one of the valid TFCs, which satisfies particular criteria. The criteria may include, for example, priority, coder-decoder (CODEC) bit rate, and the like.

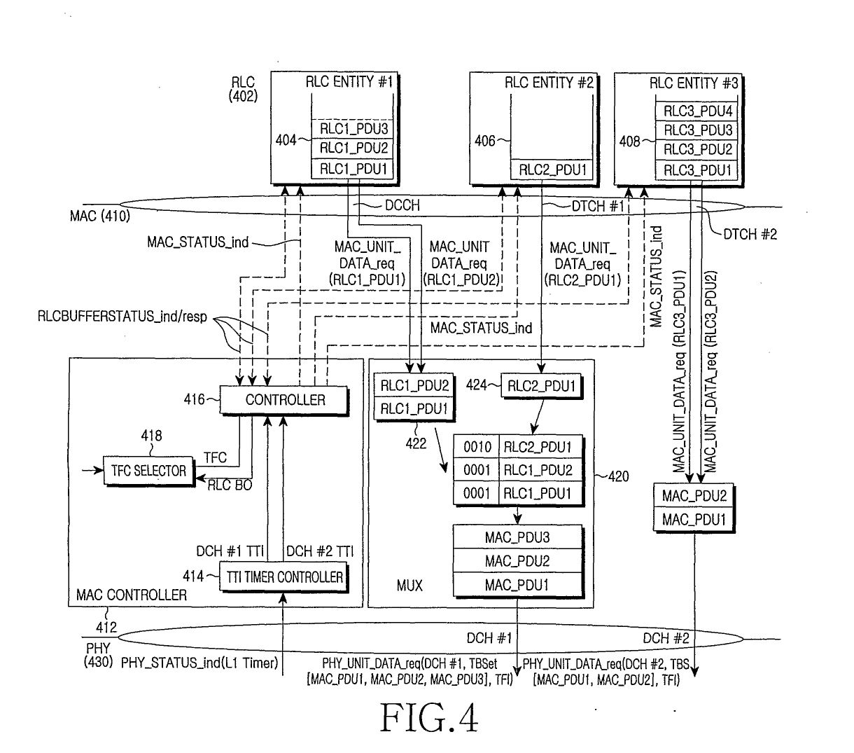

FIG. 4 shows a transmitter for selecting a TFC according to the present invention.

The transmitter of FIG. 4 includes an RLC layer 402, a MAC layer 410, and a PHY layer 430. A MAC controller 412 has a TTI timer controller 414, a TFC selector 418, and a controller 416, for controlling dedicated transport channels DCH#1 and DCH#2. The TTI timer controller 414 manages a TTI for each of the transport channels. The controller 416 sends and receives control signals to and from RLC entities #1, #2 and #3 residing in the RLC layer 402. RLC entities #1, #2 and #3 have RLC buffers 404, 406 and 408 (RLC buffers #1, #2 and #3), respectively, for storing Protocol Data Units (PDUs) to be sent on dedicated channels.

RLC buffer #1 is connected to the DCCH, and RLC buffer #2 is connected to a first DTCH (DTCH #1). The logical channels DCCH, DTCH #1 and DTCH #2 are multiplexed in a single transport channel (DCH #1) by a Multiplexer (MUX) 420. That is, PDUs 422 of the DCCH and a PDU 424 of DTCH #1 are multiplexed into MAC PDUs, MAC_PDUs 1, 2 and 3. Meanwhile, PDUs from RLC buffer #3 are provided directly to a second DCH (DCH#2) without multiplexing.

A TFC selection in the thus-configured transmitter will be described below.

The PHY layer 430 has an L1 timer (not shown). The L1 timer generates an L1 timeout signal PHY_STATUS_ind every 10 ms corresponding to the duration of a radio frame and provides it to the TTI timer controller 414. The TTI timer controller 414 activates a 10-ms timer and a 20-ms timer in response to the L1 timeout signal. The TTIs of DCH#1 and DCH#2 are respectively 10 ms and 20 ms. Upon timeout of either of the timers, the TTI timer controller 414 sends a timeout signal for the timer which has expired to the controller 416. The controller 416 sends a signal querying RLC buffer statuses, i.e. RLC Buffer Occupancy (BO) and RLCBUFFERSTATUS_ind, to the RLC buffers 404, 406 and 408 in response to the timeout signal. The RLC buffers 404, 406 and 408 send signals representing the RLC BO (the number of bits) and RLCBUFFERSTATUS_resp, to the controller 416. The controller 416 provides the RLC BO to the TFC selector 418.

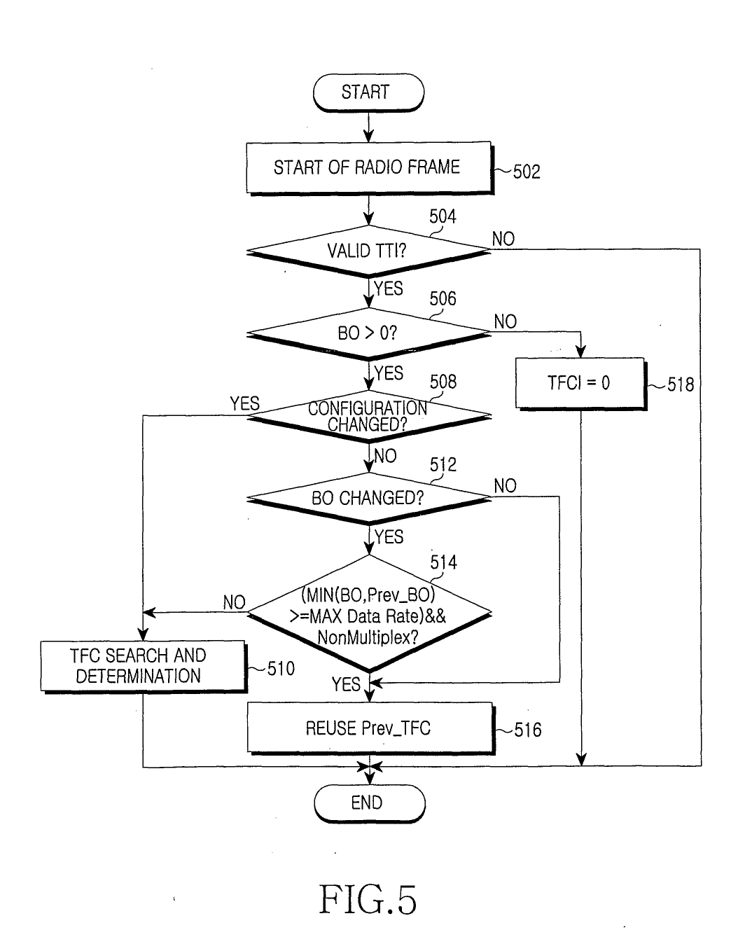

The TFC selector 418 selects a TFC describing a TB size most approximate to the RLC BO, referring to the priority levels of logical channels received from an RRC layer (not shown) and a TFCS received by higher-layer signaling, and tells the selected TFC to the controller 416. The operation of the TFC selector 418 will be described later with reference to FIG. 5.

The controller 416 sends a signal requesting PDUs corresponding to the selected TFC to the RLC buffers 404, 406 and 408. The RLC buffers 404, 406 and 408 output RLC PDUs in MAC_UNIT_DATA_req. Specifically, RLC buffer #1 outputs two PDUs, RLC1_PDU1 and RLC1_PDU2 to the MUX 420, RLC buffer #2 outputs one PDU, RLC2_PDU1 to the MUX 420, and RLC buffer #3 outputs two PDUs, RLC3_PDU1 and RLC3_PDU2 directly to the PHY layer 430.

The MUX 420 attaches logical channel Identifiers (IDs) as multiplexing information to the received RLC PDUs during multiplexing, and segments the multiplexed data into MAC_PDU1, MAC_PDU2, and MAC_PDU3. In this way, the MAC layer 410 outputs a Transport Block Set (TBS) for each transport channel every TTI. The PHY layer 430 maps PHY_UNIT_DATA_req including MAC_PDU1, MAC_PDU2, and MAC_PDU3 received from the MUX 420, and PHY_UNIT_DATA_req including MAC_PDU1 and MAC_PDU2 received from RLC buffer #3, to one or more particular physical channels, for transmission.

The above entire operation takes place every TFC selection period. Each TF in the selected TFC includes two parts, dynamic part and semi-static part. The semi-static part is set by higher-layer signaling, and the dynamic part is selected every TTI.

Attributes of the dynamic part include TB size and TBS size. The TB size represents the number of bits in each TB, and the TBS size represents the number of TBs included in a TBS. Every TB is of the same size in a TBS. Attributes of the semi-static part includes TTI size, error protection schemes (e.g. coding), code rate, static rate matching parameter, CRC size, etc. For instance, the dynamic part is [TB size=320 bits, TBS size=640 bits] and the semi-static part is [TTI=10 ms, convolutional coding, static rate matching parameter=1, . . . ].

FIG. 5 shows a TFC selection operation according to the present invention.

Referring to FIG. 5, when an L1 timeout signal indicating the boundary of a radio frame is generated, the TFC selection procedure is initialized in step 502. In step 504, the TFC selector determines whether a valid TTI boundary exists at a current time of point. That is, the TFC selector determines whether the TTI timer of at least one of active transport channels is time-out. If the TTI boundary of any transport channel is not reached, the TFC selector ends the operation for a current frame.

On the other hand, when the TTI boundary of any transport channel has been reached, the TFC selector determines whether the amount of data of logical channels mapped onto the transport channel, i.e. the RLC BO, is 0 in step 506. In other words, the TFC selector determines whether the RLC buffers have any PDU to be sent. In the absence of any data to be sent, i.e. when the RLC BO of the RLC buffers is 0 or less, the TFC selector sets a TFCI indicating a TFC for use at the current time of point to 0 in step 518, and ends the TFC selection procedure. When the TFCI is 0, this implies that no data to be sent exists, or only a minimum amount of particular data (e.g. signaling information) is sent.

When the RLC BO is larger than 0 in step 506, the TFC selector determines whether configuration parameters related to active transport channels have been changed, for example, whether the priority levels of the logical channels, a TFCS, or the like has been changed by higher-layer signaling. When the configuration parameters have been changed, compared to in a previous TFC selection period, the TFC selector performs the afore-described TFC search and determination process in accordance with parameters for the current TFC selection period, inclusive of TFCS, logical channel multiplexing information, logical channel priority, RLC BO, a time-out TTI timer for the current radio frame, and whether a time-out TTI timer for a previous radio frame still runs in step 510. Thus, the TFC selector selects a TFC for available transport channels, including a transport channel of which the TTI boundary has been reached. A detailed procedure for selecting the optimal TFC is beyond the scope of the present invention and thus it will not be described herein.

When none of the configuration parameters have been changed in step 508, the TFC selector determines whether the statuses of the RLC buffers have been changed compared to in the previous TFC selection period in step 512. Specifically, the TFC selector compares a variation of the RLC BO with a particular threshold, and when the variation is less than the threshold, determines that the RLC BO is still the same. If all the RLC buffer statuses are the same, the TFC selector decides to reuse a TFC (Prev_TFC) used in the previous TFC selection period for the current TFC selection period, thus setting the TFC of the current TFC selection period to Prev_TFC in step 516. Then, the TFC selector ends the TFC selection procedure.

On the other hand, when any of the RLC buffer statuses is changed, the TFC selector compares the current RLC BO and a previous RLC BO, Prev_BO, with a maximum TB size corresponding to an available maximum data rate MAC_Data_Rate for the current TFC selection period in step 514. The maximum TB size is the amount of data specified by a TFC with a maximum data rate among available TFCs. The maximum TB size is related to the current channel status and available power. If both the current RLC BO and the previous RLC BO are equal to or larger than the maximum TB size, and multiplexed logical channels are not mapped onto the transport channel (Non-Multiplex), the TFC selector decides to reuse Prev_TFC for the current TFC selection period in step 516. On the other hand, if at least one of the current RLC BO and the previous RLC BO is less than the maximum TB size, or multiplexed logical channels are mapped onto the transport channel, the TFC selector performs the above-described TFC search and determination process in step 510.

While not shown, it can be further contemplated as another embodiment of the present invention that the TFC selector performs only step 502 to step 512. That is, when the RLC BO has been changed in step 512, the TFC selector performs the TFC search and determination process in step 510. If the RLC BO is the same, the TFC selector decides to reuse Prev_TFC for the current TFC selection period in step 516.

In a further embodiment of the present invention, when data to be sent always exists in the RLC buffers, and the configuration parameters are not changed, the TFC selector determines whether to reuse Prev_TFC by performing only steps 512 and 514. In this way, at least one of the conditions described in FIG. 5 (i.e. steps 506 to 514) is used depending on system situations.

Table 1 below compares an embodiment of the present invention with the conventional technology in a simulation in terms of the number of occurrences of the TFC search and determination process. The simulation was performed under the conditions that a total measuring time is 5.0 seconds, a required block error rate is 0, and the data rates of the downlink and the uplink are respectively 384 kbps and 64 kbps.

TABLE 1

| | | Decrease rate of |
|---|---|---|
| | Number of | number of |
| Conventional | 250 | 100% |
| Steps 502 to 512 | 240 | 96% |
| Steps 502 to 514 | 45 | 18% |

As noted from Table 1, the number of occurrences of the TFC search and determination process can be decreased to 180% by performing the steps of FIG. 5, and particularly, step 514, compared to the conventional technology. This can be explained by the fact that the amount of data buffered in the RLC buffers is larger than a maximum data amount transmittable on a radio link in most cases of data transmission from a UE. That is, the amount of data buffered in the RLC buffers varies within a range above the maximum data amount.

The simulation results were acquired under a test environment free of transmission errors, i.e. in the case where an allowed maximum data rate for the UE is used. In a real radio environment having transmission errors, the amount of data sent on the radio link is decreased. Hence, it is expected that the present invention will perform better than in the simulation.

As is apparent from the above description, the present invention prevents unnecessary execution of the TFC search and determination process in each TTI. Therefore, an unnecessary operation is avoided, processing load is reduced, and a fast TFC selection is facilitated for a high-speed communication environment.

While the invention has been shown and described with reference to certain preferred embodiments of the present invention thereof, it will be understood by those skilled in the art that various changes in form and details may be made therein without departing from the spirit and scope of the present invention as defined by the appended claims and their equivalents.

1. A method of selecting a Transport Format Combination (TFC) for transport channels in a wireless communication system, the method comprising:
determining whether a previous TFC used for data transmission on a previous valid Transmission Time Interval (TTI) can be reused as a current TFC for data transmission on a current valid TTI via at least one transport channel according to at least one parameter related to the transport channel;
setting the previous TFC as the current TFC without performing a TFC search and determination process, when the previous TFC can be reused on the current valid TTI; and
searching TFCs, each having Transport Formats (TFs) preset for data transmission on transport channels, and selecting a suitable TFC for the current valid TTI from among the TFCs, when the previous TFC cannot be reused on the current valid TTI.

2. The method of claim 1, wherein the step of determining whether a previous TFC used for data transmission in a previous valid TTI can be reused as a current TFC comprises:
comparing a buffer occupancy for the current valid TTI and a buffer occupancy for the previous valid TTI with an available maximum Transport Block (TB) size for the current valid TTI;
determining that the previous TFC can be reused on the current valid TTI when both the buffer occupancy for the current valid TTI and the buffer occupancy for the previous valid TTI are equal to or larger than the available maximum TB size; and
determining that the previous TFC cannot be reused on the current valid TTI when at least one of the buffer occupancy for the current valid TTI and the buffer occupancy for the previous valid TTI is less than the available maximum TB size.

3. The method of claim 2, wherein the available maximum TB size represents the amount of transmittable data specified by a TFC with a maximum data rate which can be selected from among the TFCs on the current valid TTI.

4. The method of claim 1, wherein the step of determining whether a previous TFC used for data transmission in a previous valid TTI can be reused as a current TFC comprises:
determining that the previous TFC can be reused on the current valid TTI when both buffer occupancy for the current valid TTI and a buffer occupancy for the previous valid TTI are equal to or larger than an available maximum TB size for the current valid TTI, and multiplexed logical channels are not mapped onto the at least one transport channel; and
determining that the previous TFC cannot be reused on the current valid TTI when at least one of the buffer occupancy for the current valid TTI and the buffer occupancy for the previous valid TTI is less than the available maximum TB size, or the multiplexed logical channels are mapped onto the at least one transport channel.

5. The method of claim 4, wherein the available maximum TB size represents the amount of transmittable data specified by a TFC with a maximum data rate which can be selected from among the TFCs on the current valid TTI.

6. The method of claim 1, wherein the step of determining whether a previous TFC used for data transmission in a previous valid TTI can be reused as a current TFC comprises:
determining whether buffered data to be sent on the at least one transport channel exists on the current valid TTI;
determining whether configuration parameters associated with the at least one transport channel have been changed, in the presence of the buffered data;
determining whether a buffer occupancy for the current valid TTI has been changed, compared to in the previous valid TTI, if the configuration parameters have not been changed;
comparing the buffer occupancy for the current valid TTI and a buffer occupancy for the previous valid TTI with an available maximum TB size for the current valid TTI, when the buffer occupancy for the current valid TTI has been changed;
determining that the previous TFC can be reused on the current valid TTI when both the buffer occupancy for the current valid TTI and the buffer occupancy for the previous valid TTI are equal to or large than the available maximum TB size, and multiplexed logical channels are not mapped onto the at least one transport channel; and
determining that the previous TFC cannot be reused on the current valid TTI when at least one of the buffer occupancy for the current valid TTI and the buffer occupancy for the previous valid TTI is less than the available maximum TB size, or the multiplexed logical channels are mapped onto the at least one transport channel.

7. The method of claim 6, wherein the available maximum TB size represents the amount of transmittable data specified by a TFC with a maximum data rate which can be selected from among the TFCs on the current valid TTI.

8. The method of claim 6, wherein the configuration parameters include the priority levels of the logical channels mapped onto the at least one transport channel and the TFCs.

9. The method of claim 1, further comprising setting a Transport Format Combination Indicator (TFCI) indicating the current TFC to 0, in the absence of the buffered data.

10. The method of claim 6, wherein determining whether a previous TFC used for data transmission in a previous valid TTI can be reused as a current TFC, which further comprises:
determining that the previous TFC cannot be reused on the current valid TTI when the configuration parameters have been changed; and
determining that the previous TFC can be reused on the current valid TTI when the amount of the buffered data has been changed, compared to in the previous valid TTI.

11. An apparatus for selecting a Transport Format Combination (TFC) for transport channels in a wireless communication system, the apparatus comprising:
a Radio Link Control (RLC) buffer for buffering data to be sent on logical channels;
a multiplexer (MUX) for multiplexing data to be sent on logical channels to be mapped onto the same transport channel, among the logical channels, and providing the multiplexed data to a physical layer;
a selector for selecting a TFC for data transmission on at least one transport channel available for a current valid Transmission Time Interval (TTI); and
a controller for controlling the RLC buffer to send the buffered data to the physical layer via the MUX, or directly, according to the selected TFC,
wherein the selector is configured to determine whether a previous TFC used for data transmission on a previous valid TTI can be reused on the current valid TTI via at least one transport channel according to at least one parameter related to the transport channel, set the previous TFC as a current TFC without performing a TFC search and determination process when the previous TFC can be reused on the current valid TTI, search TFCs, each having Transport Formats (TFs) preset for data transmission on transport channels, and select a suitable TFC for the current valid TTI from among the TFCs when the previous TFC cannot be reused on the current valid TTI.

12. The apparatus of claim 11, wherein the selector is configured to determine that the previous TFC can be reused on the current valid TTI when both a buffer occupancy for the current valid TTI and the a buffer occupancy for the previous valid TTI are equal to or larger than an available maximum Transport Block (TB) size for the current valid TTI, and determine that the previous TFC cannot be reused on the current valid TTI when at least one of the a buffer occupancy for the current valid TTI and the a buffer occupancy for the previous valid TTI is less than the available maximum TB size.

13. The apparatus of claim 12, wherein the available maximum TB size represents the amount of transmittable data specified by a TFC with a maximum data rate which can be selected from among the TFCs on the current valid TTI.

14. The apparatus of claim 11, wherein the selector is configured to determine that the previous TFC can be reused on the current valid TTI when both a buffer occupancy for the current valid TTI and a buffer occupancy for the previous valid TTI are equal to or larger than an available maximum TB size for the current valid TTI, and the multiplexed logical channels are not mapped onto the at least one transport channel, and determine that the previous TFC cannot be reused on the current valid TTI when at least one of the buffer occupancy for the current valid TTI and the buffer occupancy for the previous valid TTI is less than the available maximum TB size, or the multiplexed logical channels are mapped onto the at least one transport channel.

15. The apparatus of claim 14, wherein the available maximum TB size represents the amount of transmittable data specified by a TFC with a maximum data rate which can be selected from among the TFCs on the current valid TTI.

16. The apparatus of claim 11, wherein the selector is configured to
determine whether buffered data to be sent on the at least one transport channel exists on the current valid TTI,
determine whether configuration parameters associated with the at least one transport channel have been changed in the presence of the buffered data, determine whether a buffer occupancy for the current valid TTI has been changed, compared to in the previous valid TTI, when the configuration parameters have not been changed,
compare the buffer occupancy for the current valid TTI and a buffer occupancy for the previous valid TTI with an available maximum TB size for the current valid TTI, when the buffer occupancy for the current valid TTI has been changed,
determine that the previous TFC can be reused on the current valid TTI when both the buffer occupancy for the current valid TTI and the buffer occupancy for the previous valid TTI are equal to or larger than the available maximum TB size, and multiplexed logical channels are not mapped onto the at least one transport channel, and
determine that the previous TFC cannot be reused on the current valid TTI when at least one of the buffer occupancy for the current valid TTI and the buffer occupancy for the previous valid TTI is less than the available maximum TB size, or the multiplexed logical channels are mapped onto the at least one transport channel.

17. The apparatus of claim 16, wherein the available maximum TB size represents the amount of transmittable data specified by a TFC with a maximum data rate which can be selected from among the TFCs on the current valid TTI.

18. The apparatus of claim 16, wherein the configuration parameters include the priority levels of the logical channels mapped onto the at least one transport channel and the TFCs.

19. The apparatus of claim 11, further comprising setting a Transport Format Combination Indicator (TFCI) indicating the current TFC to 0 in the absence of the buffered data for the at least one transport channel.

20. The apparatus of claim 16, wherein the selector is configured to determine that the previous TFC cannot be reused on the current valid TTI when the configuration parameters have been changed, and determines that the previous TFC can be reused on the current valid TTI when the amount of the buffered data has been changed, compared to in the previous valid TTI.
